(19) United States
(12) Patent Application Publication
(10) Pub. No.: US 2025/0136904 A1
(43) Pub. Date: May 1, 2025

(54) Liquor & Spirits Distilled Beverages - Cannabis Flavored

(71) Applicant: Armando G De La Torre, Santa Ana, CA (US)

(72) Inventor: Armando G De La Torre, Santa Ana, CA (US)

(21) Appl. No.: 18/454,818

(22) Filed: Oct. 30, 2023

(51) Int. Cl. C12G 3/06

(52) U.S. Cl. CPC C12G 3/06

(57) ABSTRACT

The present invention pertains to composition of a cannabis flavored improvement modification. to Liquors, Spirits and Distilled Beverages with formulation concentrates of various strengths of content.

The cannabis flavored improvement to liquors, spirits & distilled beverages begin with the process of using the cannabis plant and any of its extracted oils. Extracting the cannabis hashish or cannabis concentrate from Cannabis plant is the process of isolating the active ingredients: cannabin, cannabindon, cannabinine, and cannabinol using vegetable oil as solvent and mixing it with the concentrates of distilled or separation of the product of fermented grains, seeds, roots, fruits, vegetables or other sugars with a total alcohol content around 40%.

The object of the cannabis flavored improvement to liquors, spirits & distilled beverages have the advantage that such consumption will bring a refreshing effect as well as a cooling effect with intense stimulation and enjoyable taste experience. The present invention represents a new composition, method of preparation and applications, beyond the prior art of any to liquors, spirits & distilled beverages.

### BACKGROUND OF THE INVENTION

The extraction of the botanical, hash oil is an ancient tradition that goes back for thousands of years, is made by using a small amount of food grade, human consumption high proof alcohol and the cannabis plant encompassing several stages of the extraction, distillation and purification process. The by-product extraction, a potent oil, after the evaporation of the alcohol and is strained, is a high-quality thick resin. The different grains, fruits or sugars used, varieties and subvarieties make the most notable and well-known liquors, spirits and distilled beverages.

The present improvement to the liquors, spirits and distilled beverages cannabis flavored relates generally to a liquor, spirits and distilled beverages that is a distilled beverage made from the fermentation of sugars found from the grains, fruits and sugars once it has been cooked with a cannabis concentration added as flavoring and coloring that creates a feeling and relaxed euphoric sensation. Through the fermentation process, many factors influence the higher alcohol content of the liquor, spirits and distilled beverages which are molecules such as isobutyl alcohol and isoamyl alcohol, and ethanol. These parameters include the type of yeast strain, the age of the grains, fruits, or sugars used, temperature, and the carbon-nitrogen ratio.

### SUMMARY OF INVENTION

In accordance with the actual invention, the improvement of the extracted cannabis plant and oils mixed to the liquors, spirits and distilled beverages presents a new composition, method of preparation and application, above and beyond the prior art, producing a new cannabis flavored liquor, spirits and distilled beverages. The present invention meets the four basic criteria for its purpose (safety, ease-of-use, economic, and desirable), therefore is useful and represents a new composition. The new improved mixture Cannabis flavored liquors, spirits and distilled beverages should be prepared in processing plants that meet the current manufacturing practices aimed at ensuring a safe food supply to prevent contamination, guarantying a regulated product with a proper approved alcohol content measurement determined the specific weight per unit volume completed at an index temperature.

Different concentrations of alcohol in the human body have different effects on a person, the effects of alcohol will depend on the amount individually drunk, percentage of alcohol, timespan of the consumption, the amount of in-taken food are some of the factors contemplated. The distillation of the grains, fruits and sugars, defined as an alcoholic liquid that is the result of the distillation after fermentation of an agricultural product, gone through alcoholic fermentation will be distinguished by the concentrating increased alcohol volume with a cannabis flavored aged in barrels ready for consumption either by itself or mixed with other ingredients to form a cocktail.

1. The cannabis flavored improvement to agave liquors begins with the process of extracting the cannabis hashish or cannabis concentrate from Cannabis plant and mixing it with the byproduct alcohol of the agave plant. The Cannabis plant, an annual, dioecious and flowering plant from the Cannabaceae family is an indigenous plant originating in Asia, with its leaves that are of a palmately compound with serrated leaflets, it is believed to be used since the pre-Neolithic period for its fibers, food source and possibly psychoactive. The Cannabis plant, with its 483 identifiable chemical components and its 85 different cannabinoids produce Cannabidiol (CBD) and Tetrahydrocannabinol (THC) and harvesting the plants and extracting the heart of the agave plant or piña.

The extraction of the cannabis oil product dates back to the nineteenth century when hash oils extracted manually and dissolved or infused with vegetable oils. Modern day use extraction traditionally requires the separation of the hashish product utilizing water and filter bags with a large variety of different solvents that vaporize quickly, such as chloroform, dichloromethane, ether and others to separate the material from the resin or with temperature-controlled vaporizers that extracts the hashish without burning any plant material.
In the agave, the agave hearts are cooked for a three-day period in underground oven pits of hot rocks. The hearts are then crushed and mashed with a stone wheel then left to ferment in large barrels, where a small amount of the desired cannabis concentration and water are added. From the fermented mash is a liquid collected and distilled on clay or copper pots. Some of the distilled products will age or be left in barrels between one month and four years up to a 10-year period.
The agave plant, part of the Agavaceae family, which has over 100 species that are characterized by its thick leaves with pointy ends combining it with the extracted oils, the tetrahydrocannabinol (THC), which is psychoactive, Cannabidiol (CBD) or other Cannabinoids from the cannabis plant or hash makes the improvement to the agave liquor. The agave liquor improvement, depending on the cannabis concentration added, the cooking process, the mineral ratios, the temperature, the fermentation and distillation process, the time or aging process, the storage conditions, the protection from direct sun light creates a unique colored, flavored and aromized liquid surely to attract and satisfy a vast of consumers preferences. The agave liquor cannabis flavor improvement will reach an alcohol content of 55% and like other distilled agave liquors, the cannabis flavored agave liquor will be distilled twice resulting a 75 proof or 37.5% alcohol by volume.
